(19) United States
(12) Patent Application Publication
(10) Pub. No.: US 2012/0031279 A1
(43) Pub. Date: Feb. 9, 2012

(54) DEVICE FOR PREPARING A BEVERAGE EXTRACTED FROM A CAPSULE

(76) Inventors: Alain Mariller, Le Mont-Pelerin (CH); Jean-Paul Gaillard, Cully (CH)

(21) Appl. No.: 13/201,179

(22) PCT Filed: Feb. 11, 2010
(86) PCT No.: PCT/IB10/50632

§ 371 Date: Oct. 21, 2011

(30) Foreign Application Priority Data
Feb. 11, 2009 (IB) PCT/IB2009/050564
Feb. 18, 2009 (IB) PCT/IB2009/050663
Jul. 15, 2009 (IB) PCT/IB2009/053070
Jul. 23, 2009 (IB) PCT/IB2009/053205
Aug. 28, 2009 (IB) PCT/IB2009/053777

(51) Int. Cl. A47J 31/00

(52) U.S. Cl. 99/295

(57) ABSTRACT

Device for preparing a beverage that is extracted from a capsule comprising a capsule support and a capsule cage inside which there are at least a water inlet and means for piercing the capsule, characterized in that it further comprises interaction means intended to impart a mechanical, thermal, electrical or electromagnetic factor to said capsule when this capsule is introduced into the cage.

### FIELD OF THE INVENTION

The present invention is situated in the field of preparing drinks, for example coffee-based, by extraction of a concentrated dose, for example of ground coffee, contained in a capsule. It relates more particularly to the devices using such capsules.

### DESCRIPTION OF THE PRIOR ART

Capsules and machines operating according to the aforementioned principle have existed for many decades.

Patents U.S. Pat. No. 2,899,886, U.S. Pat. No. 2,968,560, U.S. Pat. No. 3,403,617 and U.S. Pat. No. 3,607,297 describe devices in which the capsule is initially perforated in several places, then traversed by pressurized water.

The capsule described in patent CH 605 293 or in patent EP 0 242 556 B1 comprises a membrane in its bottom portion. Pressurized water is initially inserted into the top portion of the capsule which causes a swelling of the capsule, mainly at the membrane. From a certain pressure the membrane tears, thereby allowing a water-coffee mixture to flow out.

Other capsules furnished with a membrane are described in the following patent documents: EP 0 468 079 A, EP 0 806 373 A, EP 0 554 469 A.

A device for preparing a drink extracted from a capsule as described above comprises a capsule support and a capsule cage, at least one water inlet, means for piercing the capsule and a drink outlet.

When hot water passes through the capsule, there is a relatively large temperature differential between the wall of the cage that surrounds the capsule and the content placed inside the capsule.

The content of the capsule therefore sustains a temperature drop that is harmful to the quality of the coffee.

### SUMMARY OF THE INVENTION

A first objective of the present invention is to encourage the consumer to use only capsules of which the environmental impact is minimized.

A second objective is to encourage the consumer to use only capsules made of a flexible material, that is to say capable of sustaining a plastic or elastic deformation. Specifically, this type of capsule is better suited to certain devices, in particular with respect to watertightness which must be ensured inside the capsule cage.

A third objective is to prevent the use of capsules made of a material that can deform in contact with hot water. Specifically, this type of material may induce malfunctions in certain devices.

A fourth objective consists in proposing a system detecting whether the capsule used in the capsule cage is made of metal or any other electricity-conducting material, or more generally of a type compatible with the extraction device in question.

A fifth objective is to improve the quality of the coffee obtained by extraction of a concentrated dose.

The present invention notably takes advantage of the fact that the ecologically acceptable capsules, for example made of biodegradable material, are often less rigid than the capsules made with less ecological materials.

The invention therefore relates to a device for preparing a drink extracted from a capsule comprising a capsule support and a capsule cage inside which are placed at least one water inlet and means for piercing the capsule. The device according to the invention is characterized in that it also comprises interaction means designed to impart a mechanical, thermal, electrical or electromagnetic factor to said capsule when the latter is inserted into the cage.

According to a first embodiment, the piercing means are suitable for piercing only capsules of which the coefficient of resistance to piercing is less than a value Rₚ.

Rₚ depends mainly on the type of material and to a lesser extent on the thickness of the capsule wall. This coefficient is chosen so as to allow the piercing of capsules made of biodegradable material and prevent the piercing of less ecological materials such as metal or certain plastics.

According to another embodiment of the invention, the piercing means are adapted so as to break when they interact with a capsule with a coefficient of resistance greater than Rₚ.

According to another embodiment, the piercing means are adapted so as to bend when they interact with a capsule with a coefficient of resistance greater than Rₚ.

According to another embodiment, the piercing means are adapted so as to retract, for example by means of a spring, when they interact with a capsule with a coefficient of resistance greater than Rₚ.

According to another embodiment, the piercing means are adapted so as to deform the capsule prior to its piercing, so that the capsule can be pierced.

The invention also relates to an assembly consisting of a capsule and of a device for preparing a drink extracted from a capsule, said device comprising a cage in which there is a housing designed to contain a capsule, the volume of the housing being less than that of the capsule.

A further subject of the invention is a device for preparing a drink extracted from a capsule comprising a capsule support and a capsule cage inside which are placed at least one water inlet and capsule-piercing means, characterized in that the capsule support and/or the capsule cage have dimensions so as to deform at least partially any capsule placed in the support/cage assembly when the latter is closed.

According to one embodiment of the invention, the device comprises capsule-deformation means placed in the zone of contact of the support with the cage.

Advantageously, these means have dimensions so as to induce a deformation of the collar of the capsule. In this case, the means may have the shape of a stair step.

Alternatively, or in addition, the device comprises capsule-deformation means placed on the inner face of the cage.

According to one embodiment of this variant, the inner space of the cage has a volume smaller than that of the capsule.

The inner volume of the cage can be reduced by defining it to have a height that is less than the height of the capsule.

Alternatively or in addition, the inclination of the lateral walls of the cage is greater than the inclination of the lateral walls of the capsule.

According to another embodiment of the invention, the base of the water inlet forms an integral part of the support.

The invention also makes it possible to detect whether the capsule used in the capsule cage is made of metal or any other electricity-conducting material, or more generally of a type compatible with the extraction device in question.

Such an effect makes it possible, for example, to exclude the use of other types of capsules, notably those made with a biodegradable material or not fulfilling the characteristics of compatibility with the extraction device. Conversely, the invention makes it possible to exclude the use of conductive capsules.

The invention also relates to a device for preparing a drink extracted from a capsule comprising a capsule support and a capsule cage inside which are placed at least one water inlet and means for piercing the capsule, characterized in that said cage has dimensions so as to deform at least partly any capsule, made of a material that can be, deformed in contact with hot water, which is placed in the cage, so that the capsule is retained in the cage following its contact with hot water.

According to one embodiment of the invention, the inner wall of the cage comprises a recess in which is housed a deformable element the coefficient of rigidity of which is greater than the coefficient of rigidity of the material constituting the capsule.

The recess may have the shape of an annular groove or of one or more holes.

According to another embodiment of the invention, the inner wall of the cage comprises pivoting elements of the keeper type which are adapted so as to be integrally housed in the wall of the cage if the coefficient of rigidity of the capsule is greater than a determined value and so as to emerge at least partially from said wall in the contrary case.

According to another embodiment of the invention, the inner wall of the cage comprises a relief of the harpoon type.

Finally, the inner wall of the cage may take the form of a bell and has an inner volume greater than the volume of the capsules.

The present invention also makes it possible to improve the quality of the coffee extracted from the aforementioned devices.

Accordingly, it relates to a device for preparing a drink extracted from a capsule comprising a capsule support and a capsule cage, at least one water inlet, capsule-piercing means and a drink outlet, which device is characterized in that it comprises heating means placed so as to heat the content of a capsule inserted into the device.

According to a variant of the invention, the heating means are placed so as to heat the capsule support. Any form of heating suitable for heating the content of the capsule may be envisaged (radiation, conduction, convection, etc.).

Alternatively or in addition, the heating means are placed so as to heat the capsule cage.

According to one embodiment of the invention, the capsule cage is surrounded by an electric heating element, such as for example a resistance.

Specifically, it is not necessary for the cage to be totally surrounded by the heating element. This variant however provides the advantage of more effectively and more uniformly heating the content of the capsule.

Alternatively, the electric heating element may be replaced by a heating element of the heat-exchanger type, the latter being able to take the form of a spiral tube inside which a hot fluid (gas or liquid) circulates.

According to one variant, the heat exchanger is placed in communication (branch) with the water inlet duct of the device. Thus, a portion of the water intended to pass through the capsule is drawn off to heat said capsule.

According to another embodiment of the invention, the heating element is placed inside the walls of the capsule cage. Any type of heating element may be used in this configuration (electric resistance, heat exchanger, etc.).

It is also possible to use heating means of the electromagnetic type (microwaves, induction, etc.).

Finally, the heating means are not necessarily in direct contact with the cage or the support; they may be connected to one and/or the other of these elements by means of a heat-conducting element.

### DETAILED DESCRIPTION OF THE INVENTION

The invention is described in greater detail below using nonlimiting examples illustrated by the following figures:

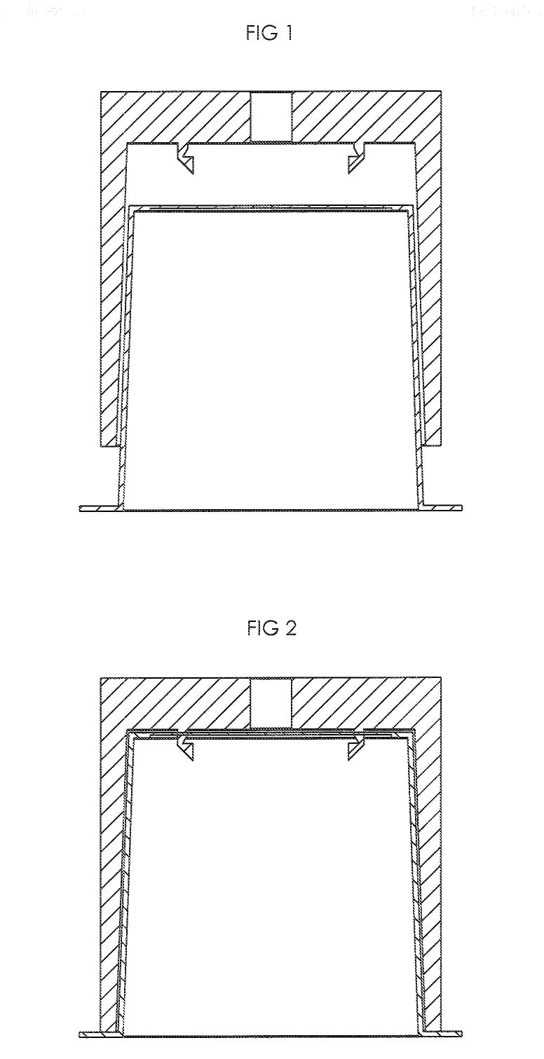

FIGS. 1 to 4 show an example of a device according to the invention with a capsule of which the piercing coefficient is less than Rₚ.

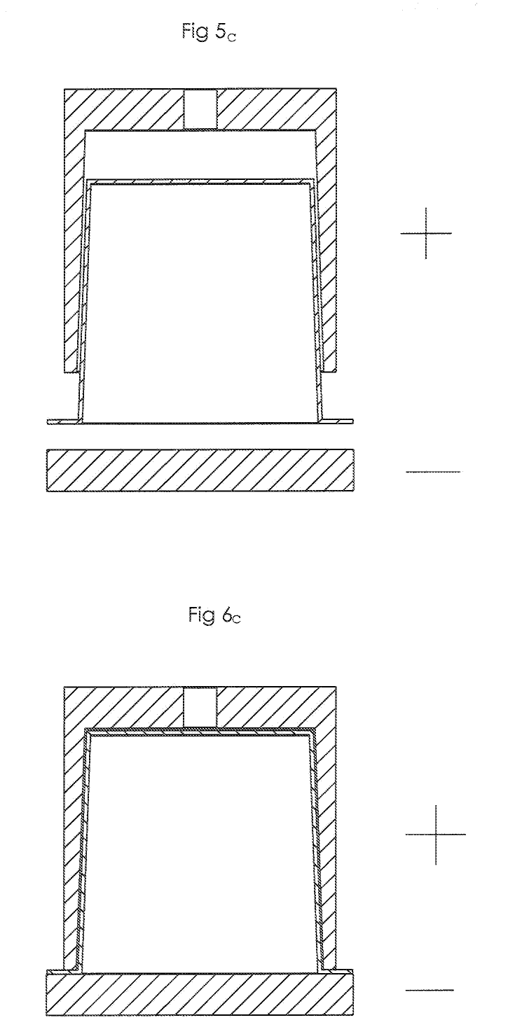

FIGS. 5 to 8 show an example of a device according to the invention with a capsule of which the piercing coefficient is greater than Rₚ.

FIGS. 9 and 10 show a capsule cage according to the invention with a spring.

FIGS. 11 to 14 show a lateral piercing and a piercing through the top.

FIGS. 15 and 16 show the lateral piercing over a portion of the length, not touching the top portion of the capsule.

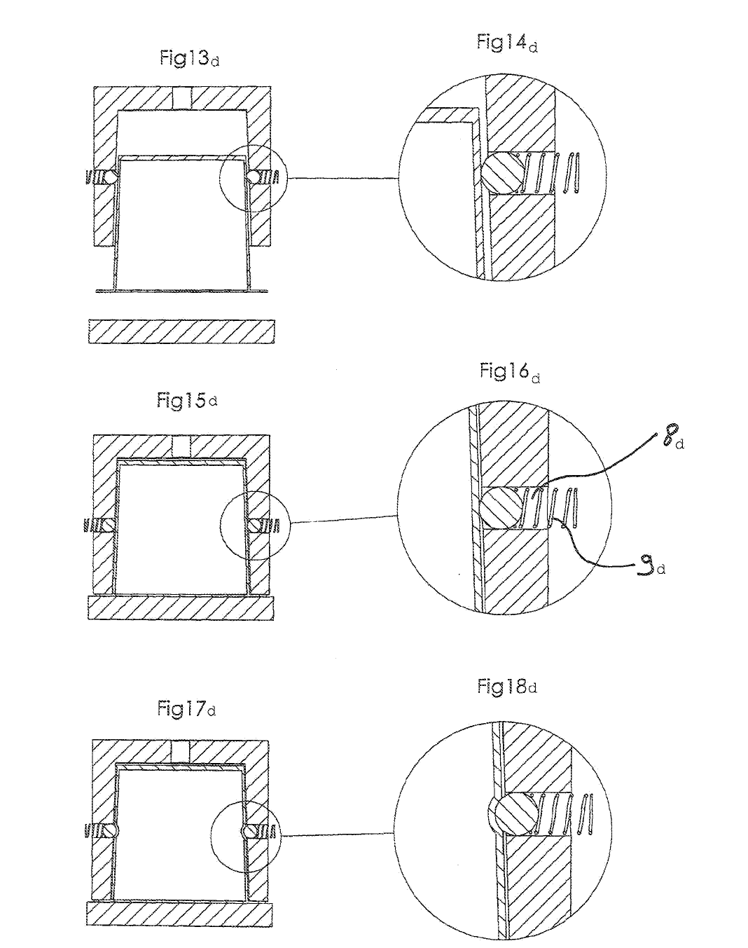

FIGS. 17 to 19 illustrate an example according to the invention wherein the capsule cage has a geometry which has the effect of deforming the capsule prior to its piercing.

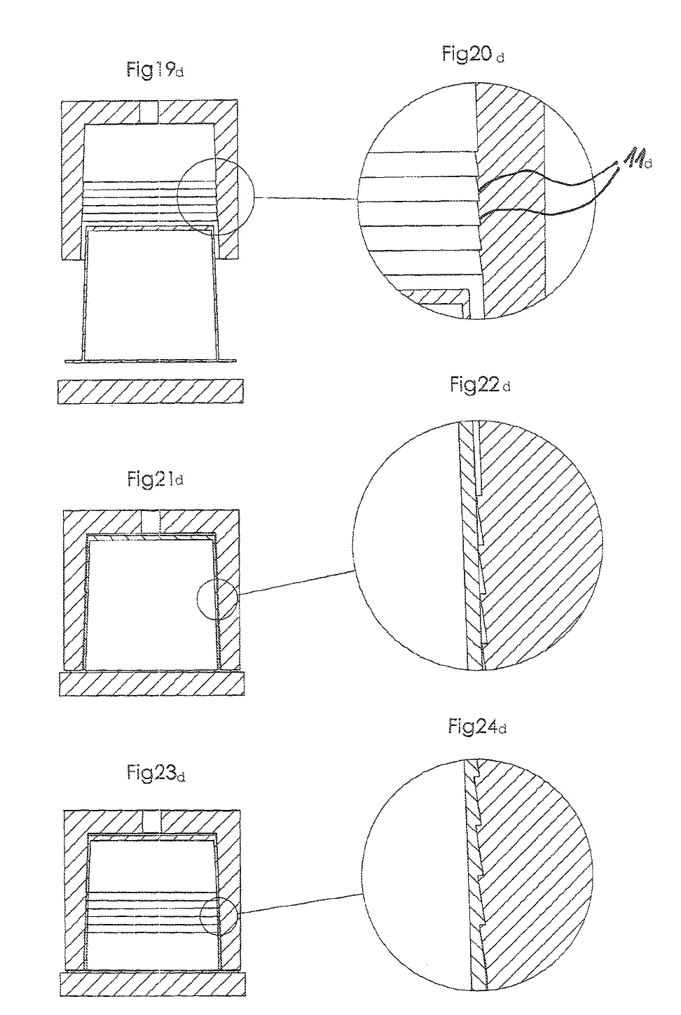

FIGS. 20 and 21 illustrate an example of a cage according to the invention in which the housing has a smaller volume than that of the capsule to be inserted, the volume reduction taking the form of lateral chicanes.

FIGS. 22 and 23 illustrate another example of a cage according to the invention in which the housing has a smaller volume than that of the capsule to be inserted, the volume reduction taking the form of lateral protrusions.

FIGS. 1a to 3b show an example of a device according to the invention wherein the collar 3a of the capsule 1a is deformed on a relief taking the form of a recess 6a placed on the support 4a.

FIGS. 1a and 1b illustrate the position of a capsule 1a before closure of the support 4a/cage 5 assembly.

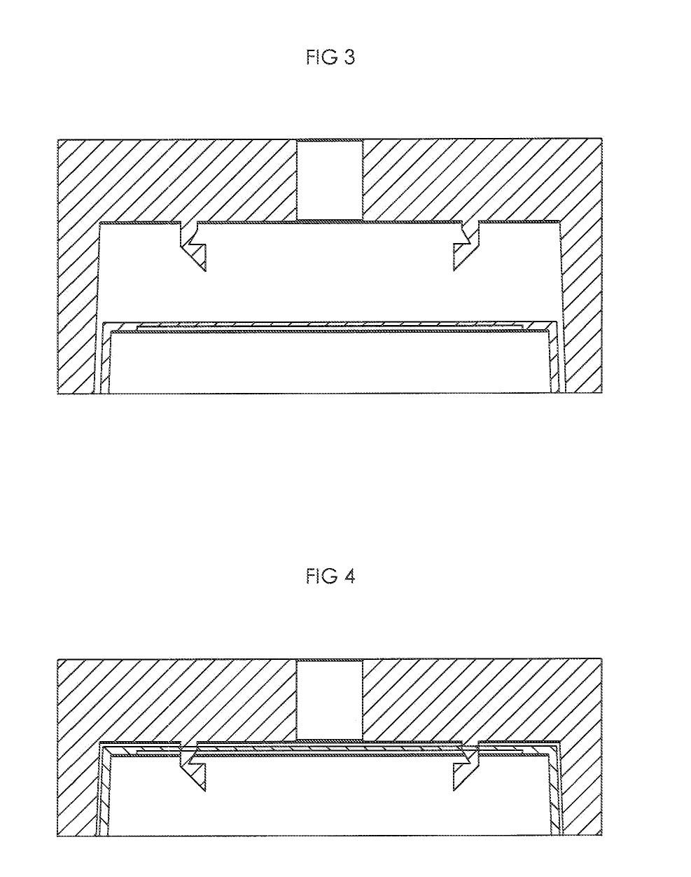

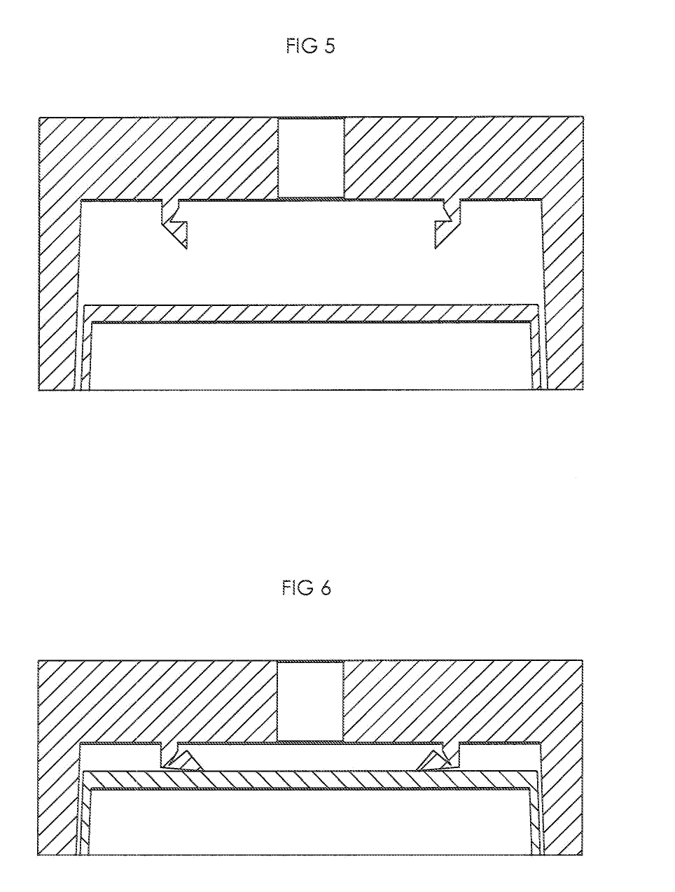

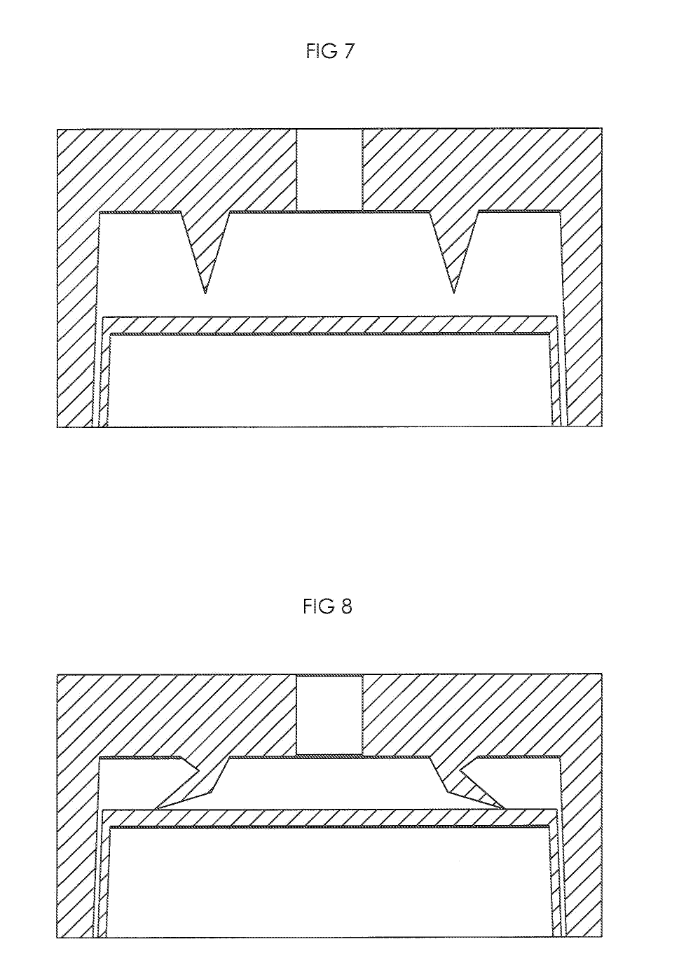

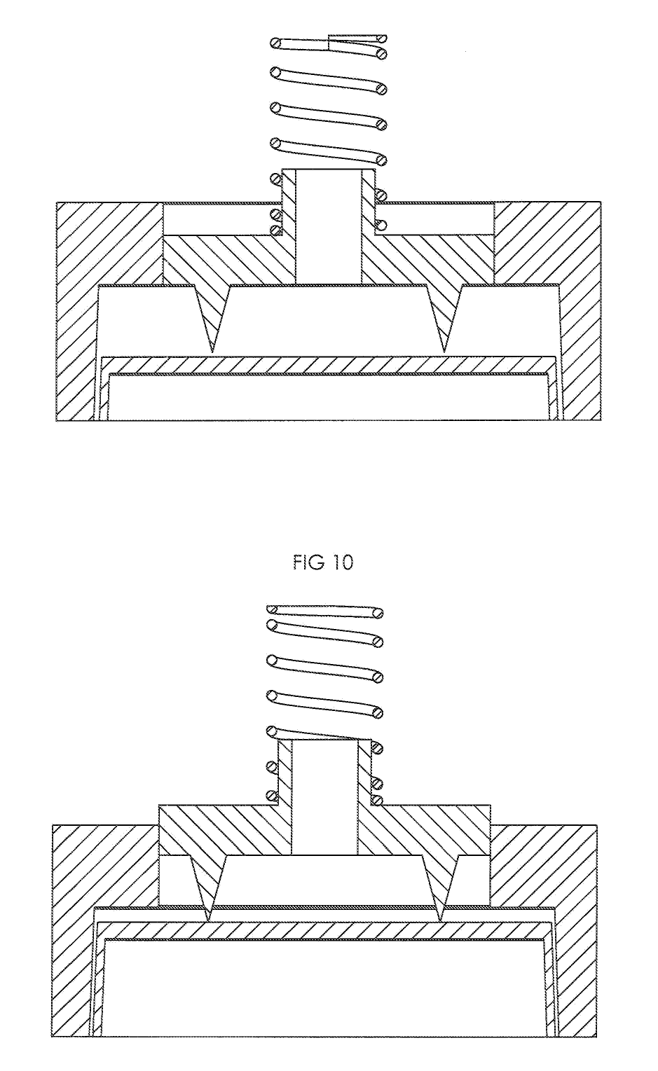

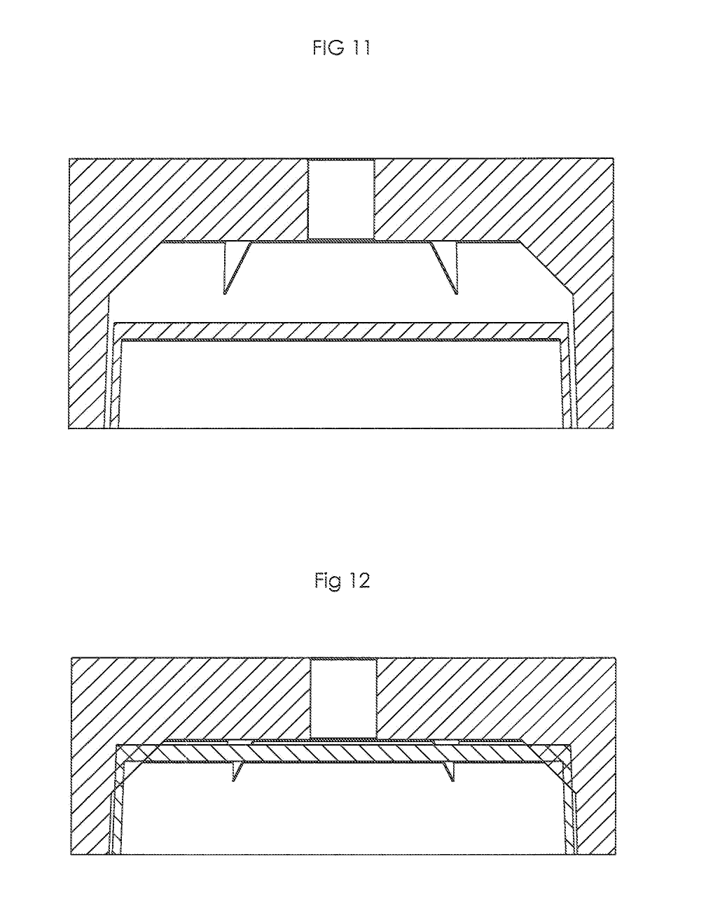

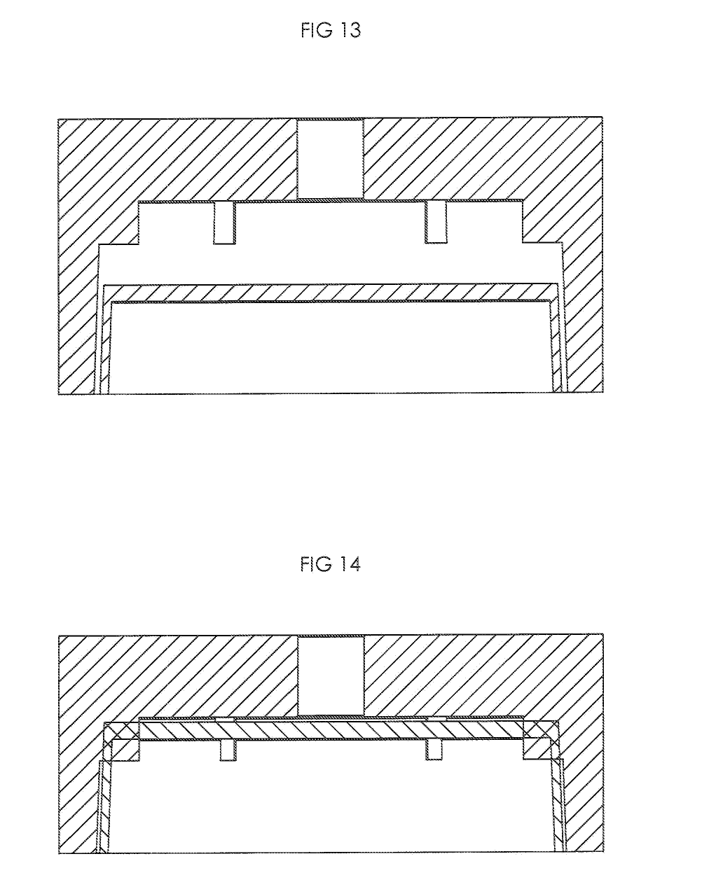

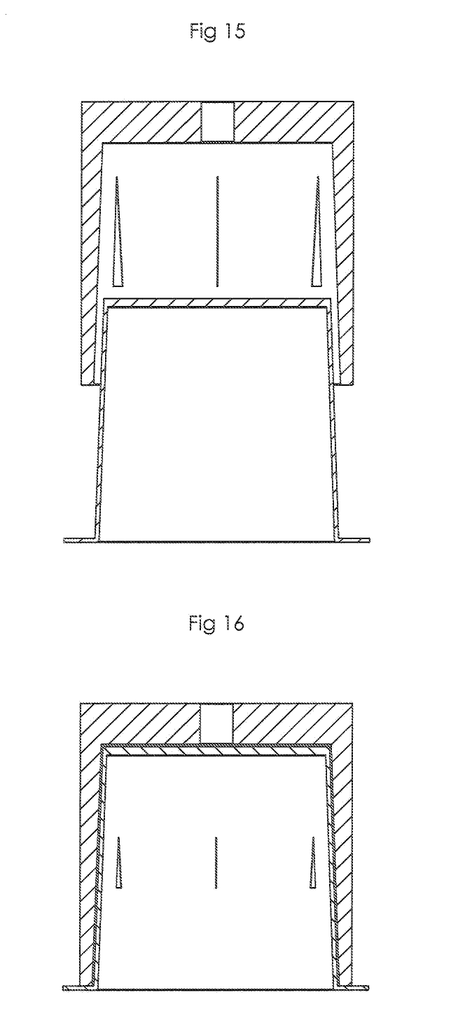

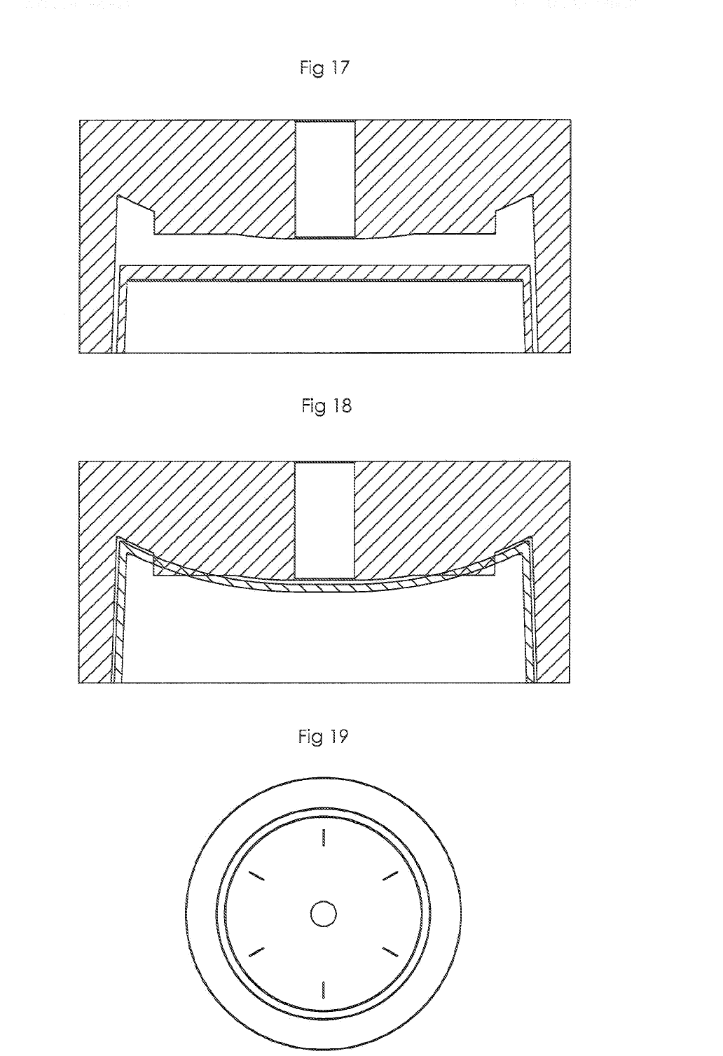

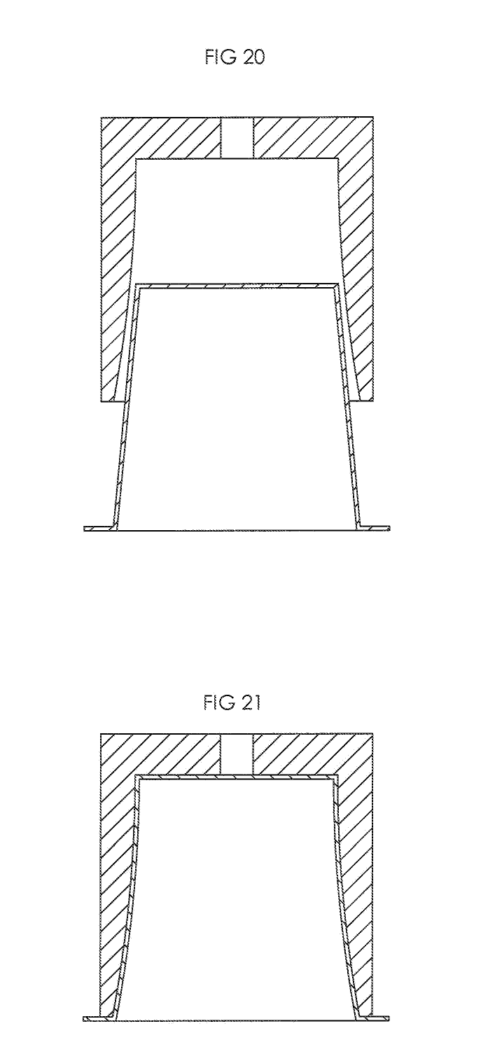

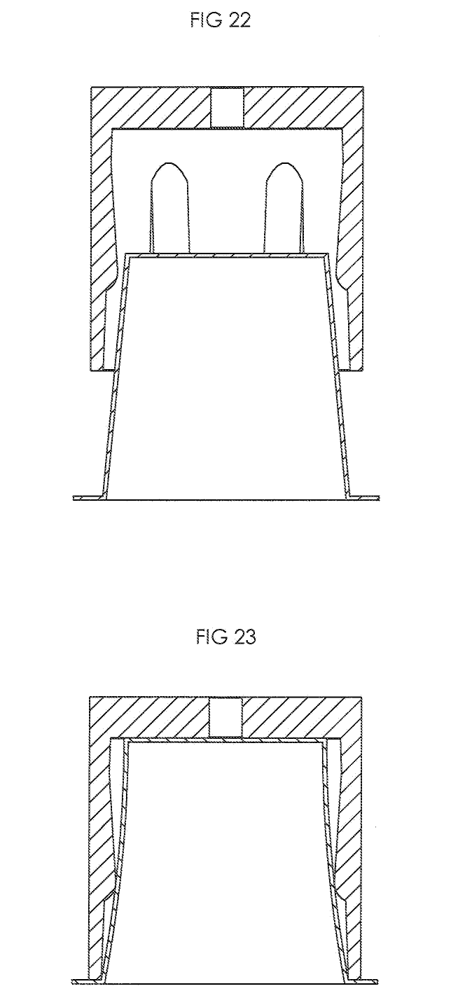

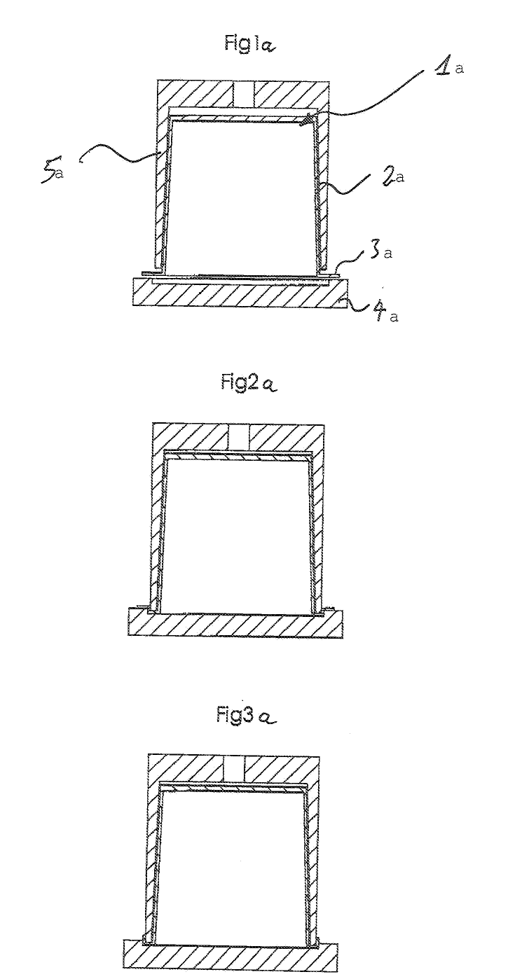

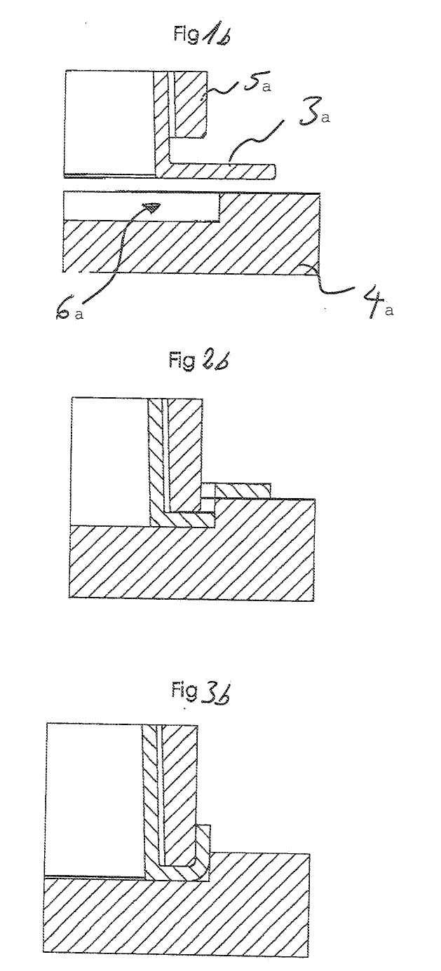

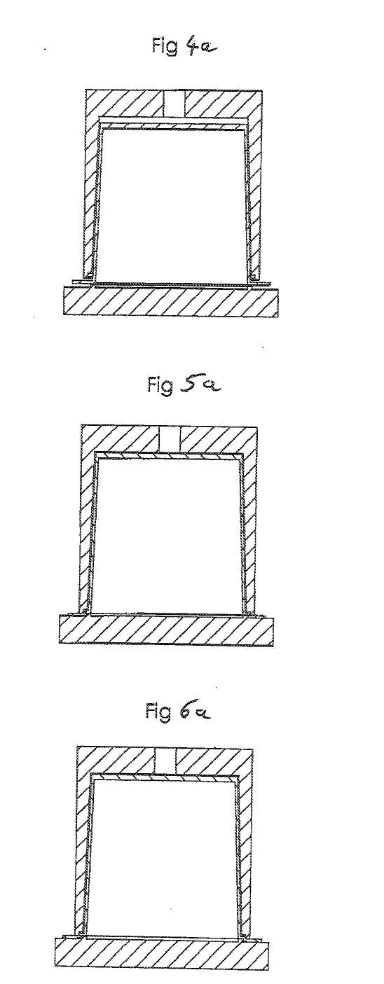

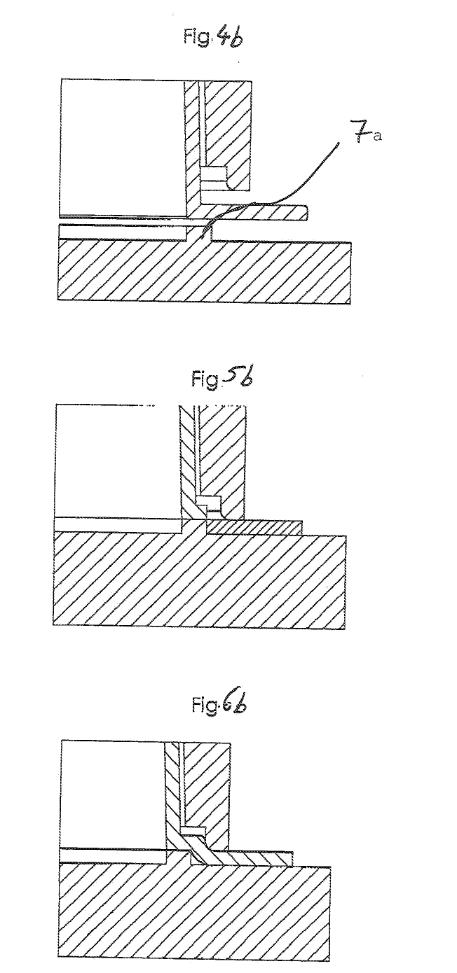

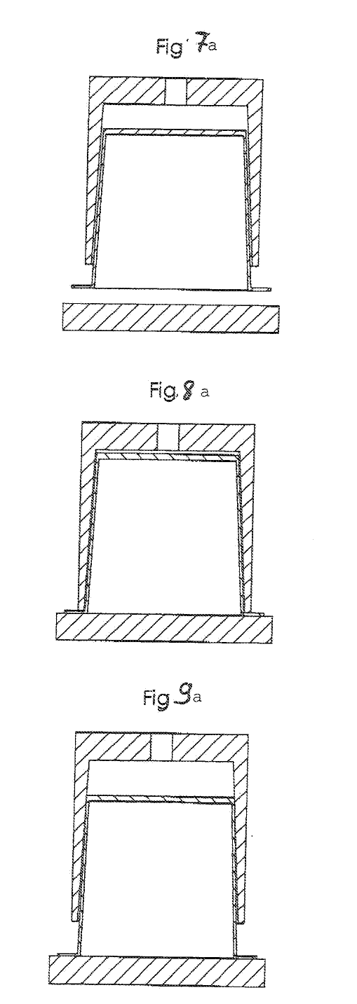

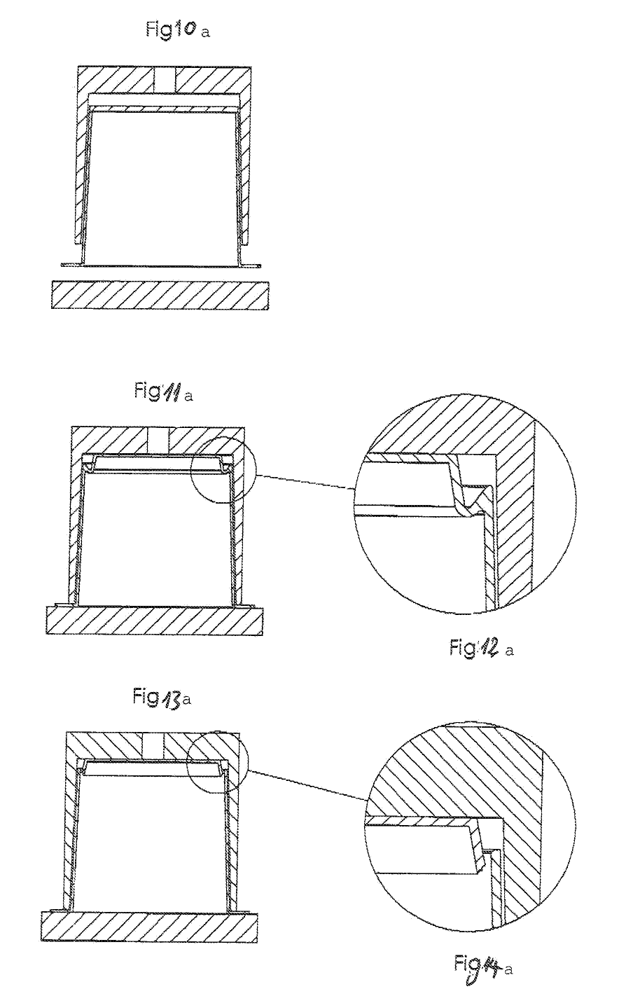

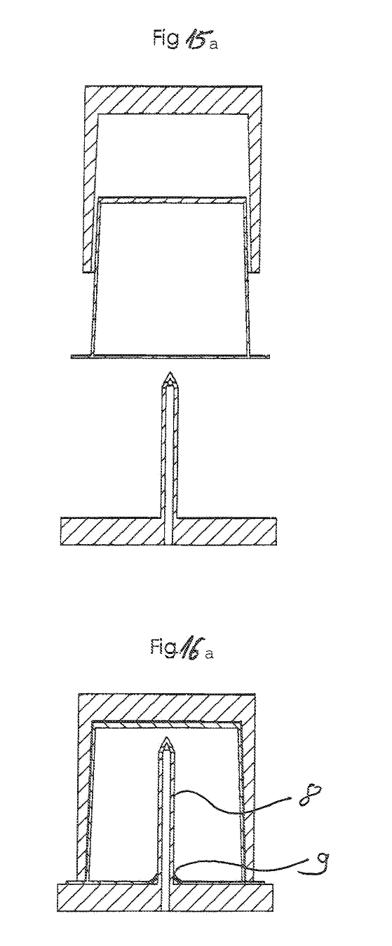

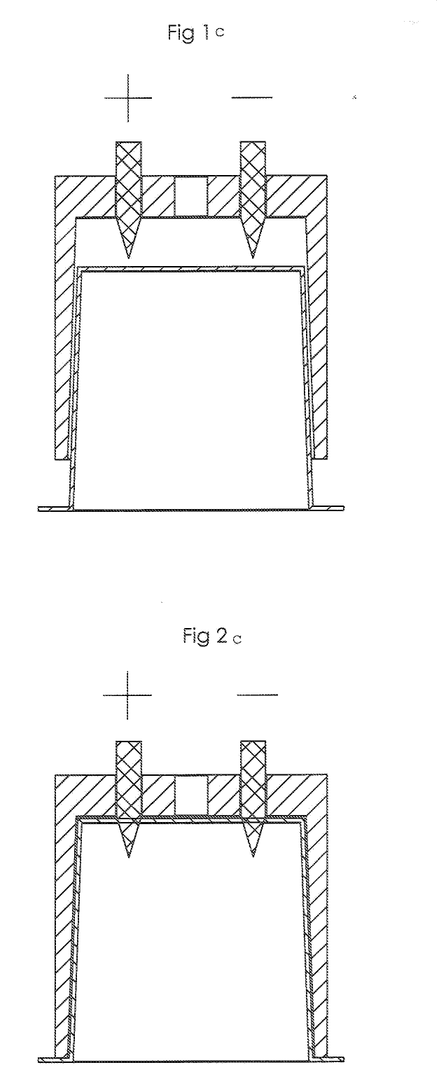

FIGS. 2a and 2b illustrate a closed support 4a/cage 5 assembly comprising a rigid capsule.

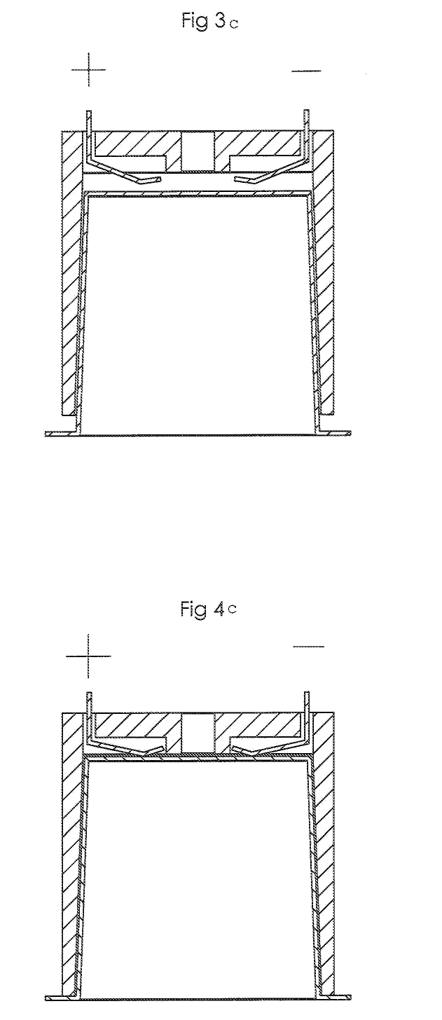

FIGS. 3a and 3b illustrate a closed support 4a/cage 5 assembly comprising a flexible capsule.

As can be seen in FIG. 2b, the insertion of a rigid capsule causes the breakage of the collar 3a while the insertion of a flexible capsule (see FIG. 3b) has the effect of deforming the collar 3a upward without breaking it. In this second case, the seal at the collar is therefore preserved.

FIGS. 4a to 6b show an example of a device according to the invention in which the collar 3a of the capsule 1a is deformed on a relief in the shape of a protuberance 7 placed on the support 4a.

FIGS. 4a and 4b illustrate the position of a capsule 1a before closure of the support 4a/cage 5 assembly.

FIGS. 5a and 5b illustrate a closed support 4a/cage 5 assembly comprising a rigid capsule.

FIGS. 6a and 6b illustrate a closed support 4a/cage 5 assembly comprising a flexible capsule.

As can be seen in FIG. 4b, the insertion of a rigid capsule causes the breakage of the collar 3a while the insertion of a flexible capsule (see FIG. 6b) has the effect of deforming the collar 3a downward without breaking it. In this second case, the seal at the collar is therefore preserved.

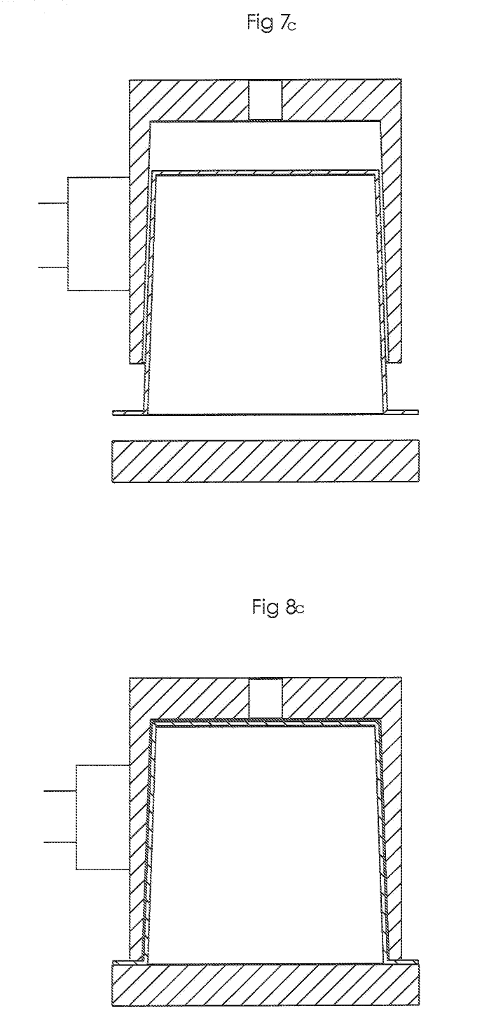

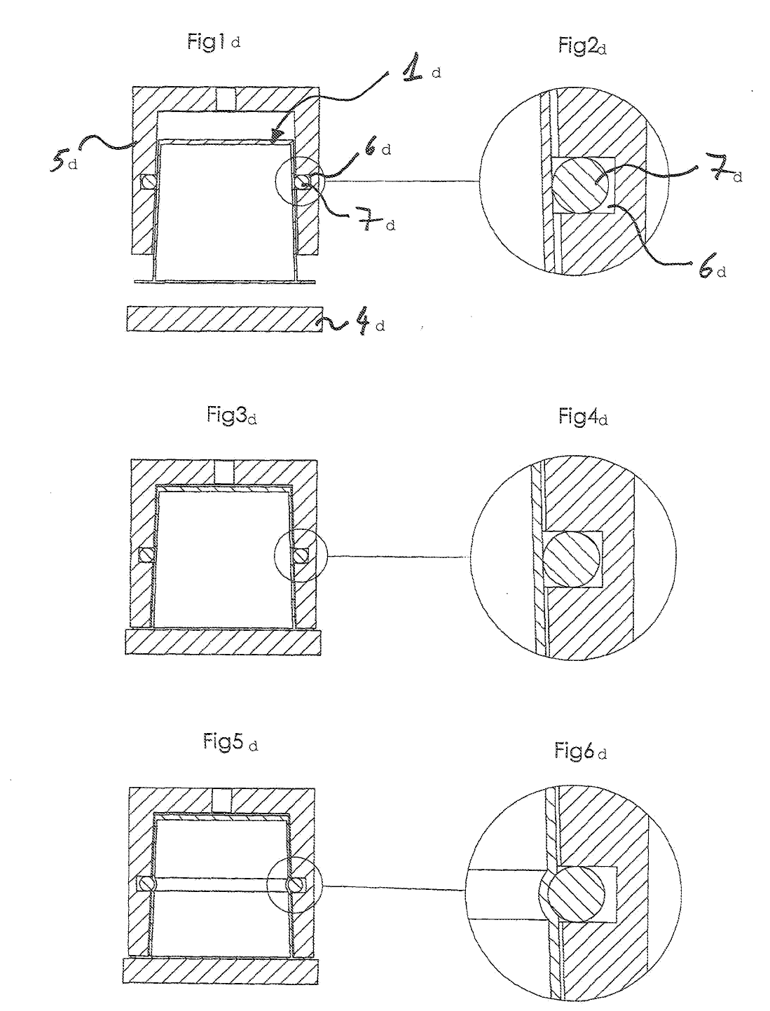

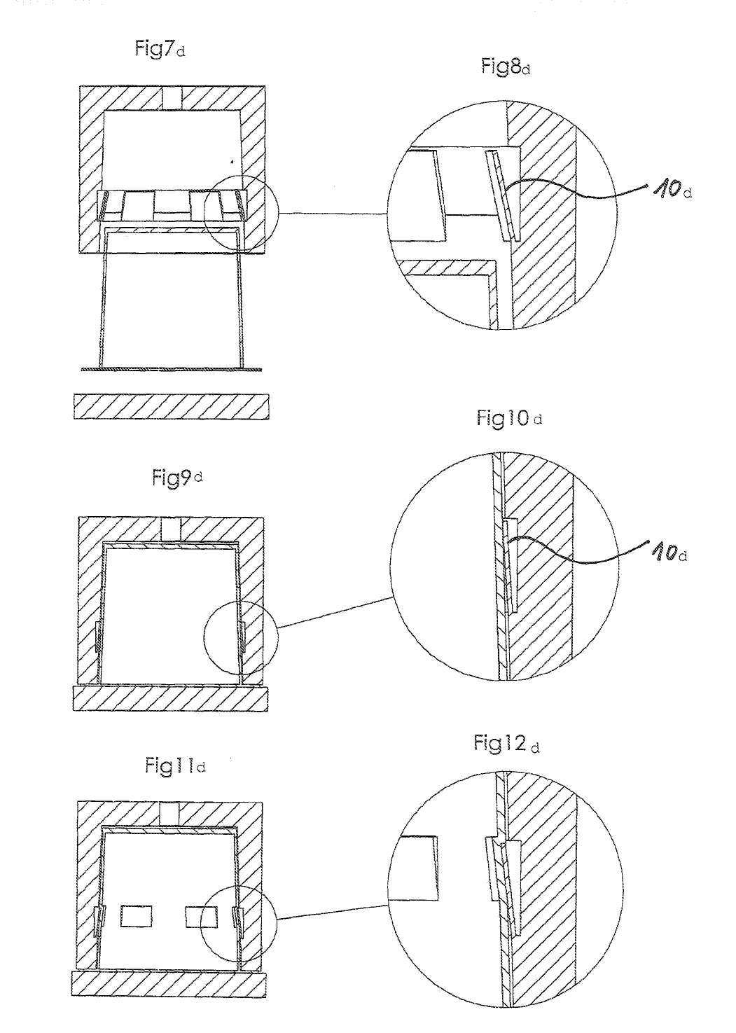

FIGS. 7a to 9a illustrate a variant of the invention in which the inclination of the lateral walls of the cage 5 is more accentuated than the inclination of the lateral wall 2a of the capsule 1a.

FIG. 7a shows the situation before closure of the support 4a/cage 5a assembly.

FIG. 8a illustrates a flexible capsule that has conformed to the restricted volume of the inside of the cage 5a.

FIG. 9 illustrates a rigid capsule that cannot be inserted into the cage 5a. Forcing the insertion of such a capsule into the cage would cause its breakage.

FIGS. 10 to 14a show a capsule cage with a lesser height than the capsule.

FIGS. 11a and 12a illustrate the use of a flexible capsule which, once inserted into the cage 5a, bends at its top portion.

FIGS. 13a and 14a illustrate the use of a rigid capsule which, once inserted into the cage 5a, breaks at its top portion.

Finally FIGS. 15a and 16a show another variant in which the water inlet takes the form of a needle 8 of which the base 9a is situated on the support 4a.

FIG. 16a illustrates a use of a flexible capsule. Its bottom portion, once pierced by the needle 8, conforms to its periphery, thereby ensuring a good seal in this place.

FIGS. 1c to 4c illustrate the principle of measuring the conductivity.

FIGS. 5c to 8c describe a capsule made of metal.

FIGS. 1d to 6d show an example of a device according to the invention wherein the inner wall of the cage comprises a recess in the form of an annular groove.

FIGS. 7d to 12d show a cage with one or more recesses.

FIGS. 13d to 18d show variants operating in a manner similar to those of FIGS. 1d to 6d.

FIGS. 19d to 24d illustrate a cage inner wall which comprises an indented relief in the form of a harpoon.

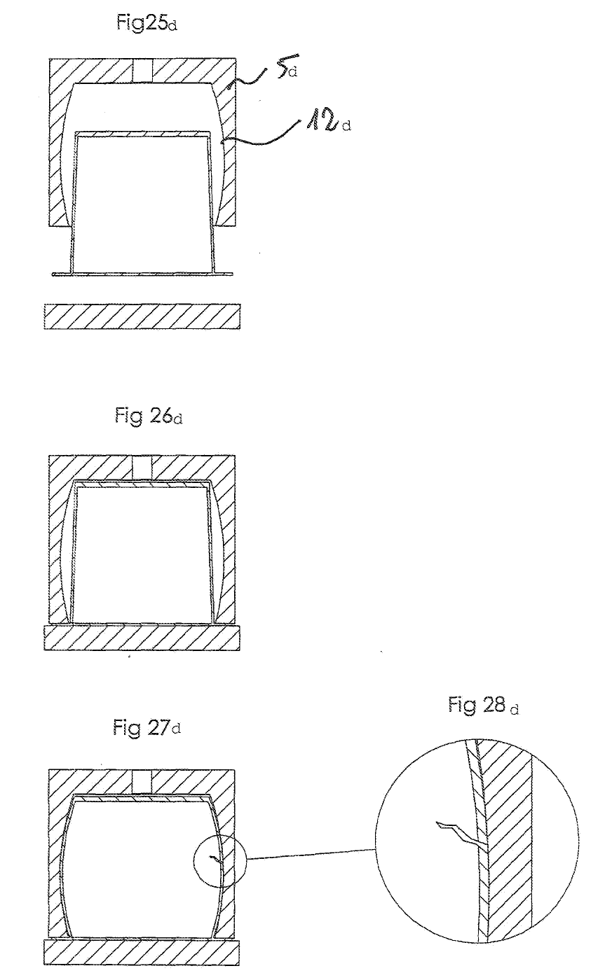

FIGS. 25d to 28d show a bell-shaped cage of which the inner volume is greater than that of the capsules.

FIGS. 1e and 2e illustrate an embodiment in which the capsule cage is surrounded by a spiral element forming an electric resistance.

FIGS. 3e and 4e are similar to FIGS. 1e and 2e but differ in that the resistance is replaced by a heat exchanger 7e in the form of a spiral tube inside which a heat-conducting fluid (gas or liquid) circulates.

FIGS. 5e and 6e show another variant with heat exchanger but in which the latter is incorporated into the wall of the capsule cage.

FIGS. 7e and 8e illustrate another variant with heating of the electromagnetic type, for example microwaves.

FIGS. 9e and 10e show another variant in which the heating means are not in direct contact with the cage or the support.

FIGS. 1f and 2f show an embodiment of a device according to the invention in which the piercing means comprise a needle mounted on a spring, the tension of the latter being adjusted so that the needle sinks through the capsule when the latter has reached a certain degree of softening. This embodiment is naturally applicable only to capsules made of a material which softens when it makes contact with hot water.

The blade illustrated in FIGS. 11 to 14 is adapted to pierce mainly the top wall of the capsule. It may however be extended downward, to mid-height or to the edge of the capsule.

Similarly, the piercing illustrated in FIGS. 15 and 16 may be carried out over the whole periphery of the capsule.

The cages shown in FIGS. 20 to 23 therefore only allow the use of deformable capsules, namely capsules with a low coefficient of rigidity.

Conversely, the use of a rigid capsule (not illustrated) would cause leaks, for example of dregs, in this place.

The devices shown in the figures discussed above therefore only allow the use of deformable capsules, namely of capsules with a low coefficient of rigidity.

The invention also makes it possible to detect whether the capsule used in the capsule cage is made of metal or any other electricity-conducting material, or more generally of a type compatible with the extraction device in question.

Such an effect makes it possible, for example, to exclude the use of other types of capsules, notably those manufactured with a biodegradable material or not fulfilling the characteristics of compatibility with the extraction device. Conversely, the invention makes it possible to exclude the use of conductive capsules.

There are two main ways of detecting a metal, for example aluminum, one by conductivity, that is to say that a place of the capsule is touched or perforated by a part also used as an electrical terminal. Another part also being able to pierce or touch the capsule in another place is also used as an electric terminal. If the current travels between the two terminals before the injection of the water, the capsule is made of metal. This, for example, prevents the starting of the pump of the machine, and therefore prevents the extraction.

FIGS. 1c to 4c illustrate this principle, FIGS. 1c and 2c with terminals that pierce the capsule, FIGS. 3c and 4c with terminals that come into contact with the capsule. Naturally, these figures are only an illustration of the principle and must not be considered to be limiting. Specifically, the terminals may be placed elsewhere than toward the bottom of the capsule.

Similarly, the other way is to have an element for detecting metal by a change of electrical or physical properties for example or magnetism or any other valid method for detecting nonferrous metals, detecting, through the wall of the cage for example or in direct contact in any place with the capsule, if the latter is made of metal (FIGS. 5c to 8c).

As a matter of fact any conductive means placed in contact with the capsule can be used to check that the capsule is of a compatible type (for example conductive) and prevent the operation of the machine if the detected capsule is not of a compatible type.

In addition to electrical conduction, it is possible for example to measure the electrical resistance, magnetic effects etc.

It is also possible to use the capsule to close a circuit, for example if the cage is in two (or more) portions that are electrically insulated from one another. The use of an electrically conductive capsule may then be easily detected, the contact between the various insulated elements being achieved by said capsule.

It is also possible to envisage other equivalent detection means which would make it possible to recognize compatible capsules, for example: thermal conduction, optical properties etc., all these means being used as a matter of fact to differentiate the capsules that can be used with the extraction device in question from those that cannot be and must not allow a correct operation of the extraction device.

Naturally, several different detection means may be combined in one and the same extraction device.

FIGS. 1d to 6d show an example of a device according to the invention in which the inner wall of the cage 5d comprises a recess 6d in the form of an annular groove, the inside of the recess 6d being occupied by a slightly deformable element 7d, for example an O-ring or a spring, which, by allowing itself to be compressed slightly, allows the insertion of a rigid capsule into the cage 5d, without the capsule 1d being deformed. If the capsule 1d is softened as a result of it being placed in contact with hot water (see FIGS. 5d and 6d), the lateral wall of the capsule 1d is deformed at the recess 6d. Once the hot water has been discharged, the capsule 1d stiffens and remains locked in the cage 5d, thereby making the device inoperative.

It is appropriate to point out that the slightly deformable element 7d must be adapted so as to exert a certain force in the direction of the center of the cage 5d.

The variant illustrated in FIGS. 13d to 18d operates in a manner similar to that of FIGS. 1d to 6d. It differs only in that the recess takes the form of at least one cylindrical hole 8d in which a spring 9d is placed.

Preferably, several holes 8 distributed around the capsule 1d are used.

The variant shown in FIGS. 7d to 12d also shows a cage 5d with one or more recesses. In this case, however, the deforming element has the shape of a keeper 10d pivoting about a horizontal axis. When the capsule 1d is inserted into the cage, the keeper 10d is fully housed in its recess. Once the capsule 1d is softened, each keeper 10d sinks into the wall of the capsule 1d. The geometry of the keepers 10d has the effect of inducing a harpoon effect. As can be seen in FIGS. 11d and 12d, the capsule 1d is retained in the cage 5d.

The variant of FIGS. 19d to 24d is characterized by an inner wall of the cage 5d which comprises an indented relief in the form of a harpoon 7d. When the capsule 1d softens, a portion of its material is housed between the indentations of the cage 5d, thereby retaining the capsule 1d in the cage 5d.

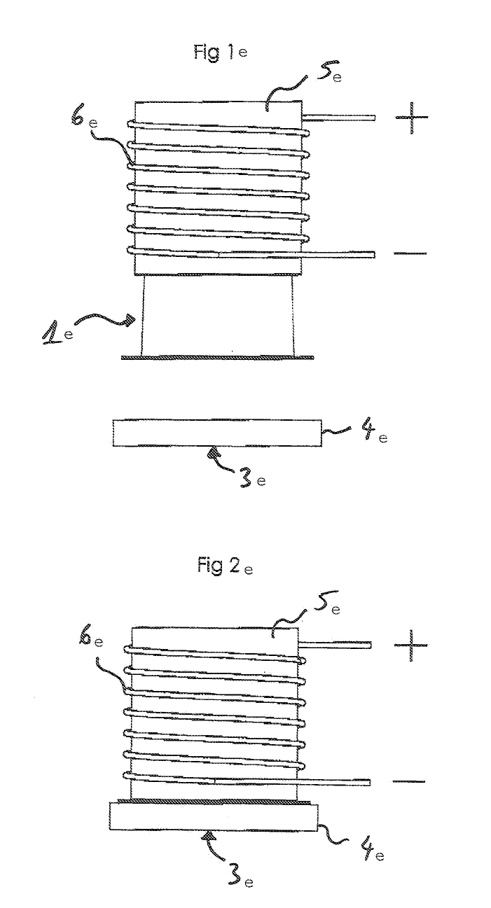

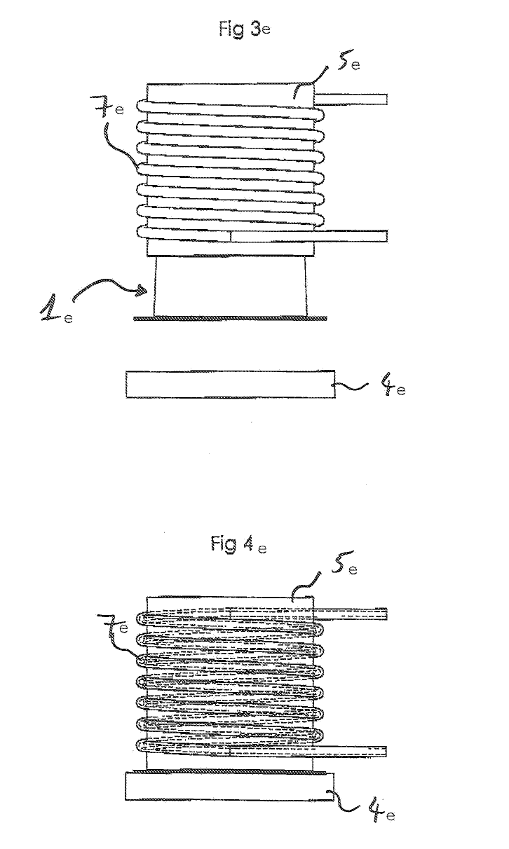

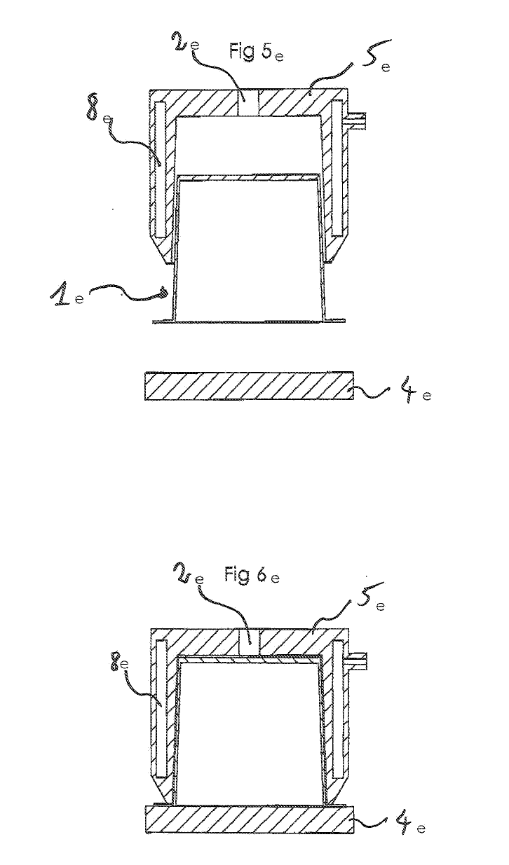

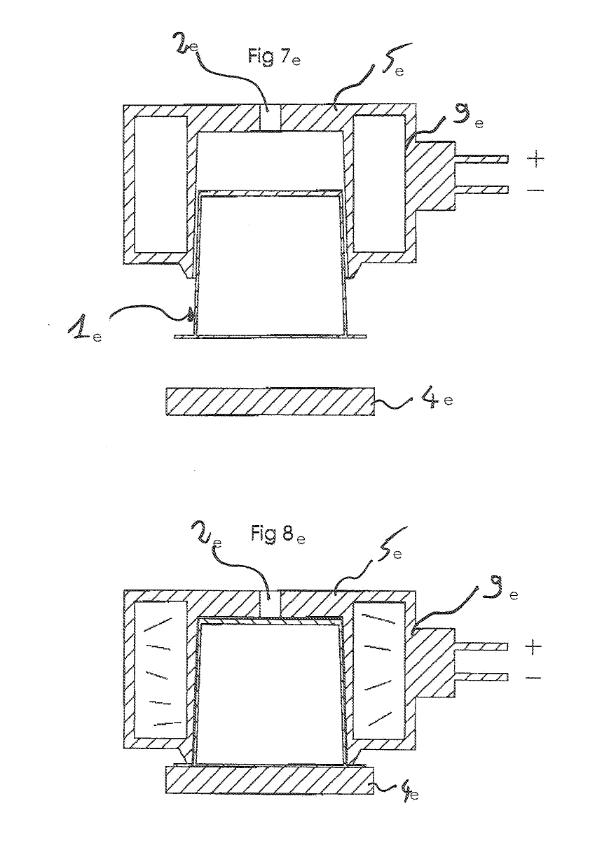

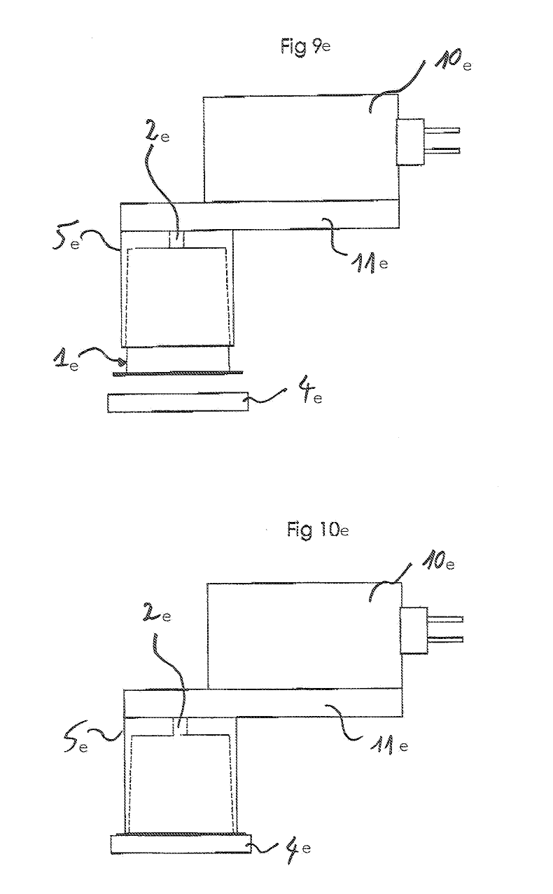

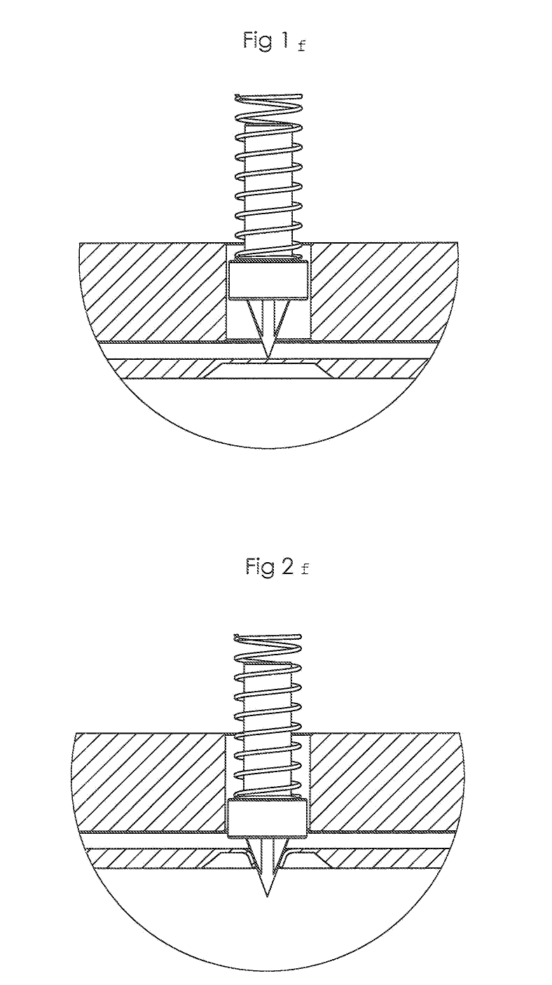

Finally, the variant of FIGS. 25d to 28d shows a cage 5d in the form of a bell of which the inner volume is greater than that of the capsules. When the hot water enters a capsule that can be deformed in contact with it, the deformation is such that its lateral wall may break open (see FIGS. 27d and 28d). The capsule is therefore unusable.

Moreover, once the hot water has been discharged, the capsule 1d is locked in the cage 5d.

FIGS. 1e and 2e illustrate an embodiment in which the capsule cage 5e is surrounded by a spiral element forming an electric resistance 6e.

FIG. 1e shows the device open and FIG. 2e the device closed (operating mode).

FIGS. 3e and 4e are similar to FIGS. 1e and 2e but differ in that the resistance is replaced by a heat exchanger 7e in the form of a spiral tube inside which a heat-conducting fluid (gas or liquid) circulates.

According to one variant that is not illustrated, the heat exchanger is in communication, via a branch, with the water inlet duct of the device.

FIGS. 5e and 6e show another variant with heat exchanger but in which the latter 8e is incorporated into the wall of the capsule cage 5e.

FIGS. 7e and 8e illustrate another variant with a heating of the electromagnetic type 9e, for example microwaves.

FIGS. 9e and 10e show another variant in which the heating means 10 are not in direct contact with the cage 5e or the support 4e but by means of a heat-conducting element 11e, made of metal for example, but it may also be a reservoir containing liquid.

It will be noted in particular that the heating means are not necessary adapted to heat the cage or the capsule support, prior to the heating of the content of the capsule.

1. A device for preparing a drink extracted from a capsule comprising a capsule support and a capsule cage inside which are placed at least one water inlet and means for piercing the capsule, characterized in that it also comprises interaction means designed to impart a mechanical, thermal, electrical or electromagnetic factor to said capsule when the latter is inserted into the cage.

2. The device as claimed in claim 1, characterized in that the piercing means are suitable for piercing only capsules of which the coefficient of resistance to piercing is less than a value Rₚ.

3. The device as claimed in claim 2, wherein the piercing means are adapted so as to break when they interact with a capsule with a coefficient of resistance greater than Rₚ.

4. The device as claimed in claim 2, wherein the piercing means are adapted so as to bend when they interact with a capsule with a coefficient of resistance greater than Rₚ.

5. The device as claimed in claim 2, wherein the piercing means are adapted so as to retract when they interact with a capsule with a coefficient of resistance greater than Rₚ.

6. The device as claimed in claim 2, wherein the piercing means are adapted so as to deform the capsule prior to its piercing.

7. An assembly consisting of a capsule and of a device as described in claim 1 characterized in that the volume of the housing of the cage is less than that of the capsule.

8. The device as claimed in claim 1, characterized in that said support and/or said cage have dimensions so as to deform at least partially any capsule placed in the support/cage assembly when the latter is closed.

9. The device as claimed in claim 8, comprising capsule-deformation means placed in the zone of contact of the support with the cage.

10. The device as claimed in claim 8, wherein said means have dimensions so as to induce a deformation of the collar of the capsule.

11. The device as claimed in claim 8, comprising capsule-deformation means placed on the inner face of the cage.

12. The device as claimed in claim 8, wherein the inner space of the cage has a volume smaller than that of the capsule.

13. The device as claimed in claim 12, wherein the height of said space is less than the height of the capsule.

14. The device as claimed in claim 12, wherein the inclination of the lateral walls of the cage is greater than the inclination of the lateral walls of the capsule.

15. The device as claimed in claim 8, wherein the base of the water inlet forms an integral part of the support.

16. The device as claimed in claim 1, wherein one or more detection means are provided to determine whether the inserted capsule is of a compatible type.

17. The device as claimed in claim 16, wherein the detection means is electrical or magnetic.

18. The device as claimed in claim 16, wherein the detection means is optical.

19. The device as claimed in claim 16, wherein the detection means is thermal.

20. The device as claimed in claim 16, wherein the electrical detection means comprise electrical contacts.

21. The device as claimed in claim 20, wherein the electrical contacts touch the capsule.

22. The device as claimed in claim 16, wherein the detection means comprises a metal detector or other equivalent means.

23. An assembly formed of a device as claimed in claim 16 and of at least one capsule that can be detected by said detection means.

24. The device as claimed in claim 1, characterized in that said cage has dimensions so as to deform at least partly any capsule, made of a material that can be deformed in contact with hot water, which is placed in the cage, so that the capsule is retained in the cage following its contact with hot water.

25. The device as claimed in claim 24, wherein the inner wall of the cage comprises a recess in which is housed a deformable element the coefficient of rigidity of which is greater than the coefficient of rigidity of the material constituting the capsule.

26. The device as claimed in claim 25, wherein said recess is an annular groove.

27. The device as claimed in claim 25, wherein the recess is a hole.

28. The device as claimed in claim 27, comprising several recesses in the form of holes.

29. The device as claimed in claim 24, wherein the inner wall of the cage comprises pivoting elements of the keeper type which are adapted so as to be integrally housed in the wall of the cage if the coefficient of rigidity of the capsule is greater than a determined value and so as to emerge at least partially from said wall in the contrary case.

30. The device as claimed in claim 24, wherein the inner wall of the cage comprises a relief of the harpoon type.

31. The device as claimed in claim 24, wherein the inner wall of the cage is bell-shaped and has an inner volume greater than the volume of the capsules.

32. The device as claimed in claim 1, characterized in that it comprises heating means placed so as to heat the content of a capsule inserted into the device.

33. The device as claimed in claim 32, wherein said heating means are placed so as to heat the capsule support.

34. The device as claimed in claim 32, wherein the heating means are placed so as to heat the capsule cage.

35. The device as claimed in claim 34, wherein the capsule cage is surrounded by an electric heating element such as a resistance.

36. The device as claimed in claim 34, wherein the capsule cage is surrounded by a heating element of the heat-exchanger type.

37. The device as claimed in claim 36, wherein said heating element comprises a duct of which one end is in communication with the duct of said water inlet.

38. The device as claimed in claim 34, wherein the heating element is placed inside the walls of the capsule cage.

39. The device as claimed in claim 32, wherein the heating means are of the electromagnetic type, for example of the microwave type.

40. The device as claimed in claim 32, wherein the heating means are connected to the capsule cage and/or to the capsule support by means of a heat-conducting element.

41. The device as claimed in claim 1, wherein the piercing means comprise a needle mounted on a spring, the tension of the latter being adjusted so that the needle sinks through the capsule when the latter has reached a certain degree of softening.
